(19) United States
(12) Patent Application Publication
(10) Pub. No.: US 2022/0124022 A1
(43) Pub. Date: Apr. 21, 2022

(54) REDUCING PACKET DROPS DURING A SWITCH RESTART

(71) Applicant: VMware, Inc., Palo Alto, CA (US)

(72) Inventors: Jayaramakrishnan Shenbagam, Sunnyvale, CA (US); Bhushan Mangesh Kanekar, Saratoga, CA (US)

(21) Appl. No.: 17/076,560

(22) Filed: Oct. 21, 2020

(51) Int. Cl. H04L 12/707; H04L 12/24; H04L 12/741; H04L 12/26

(52) U.S. Cl. CPC H04L 45/22; H04L 43/0876; H04L 45/745; H04L 41/082

(57) ABSTRACT

Described herein are systems, methods, and software to manage the update of switches in a computing network. In one example, a control service identifies a request to update a first switch and modifies the network configuration of the first switch to divert network traffic to a second switch that provides an alternate path to a path provided by the first switch. After updating the network configuration, the control service monitors the network traffic of the first switch to determine when the traffic has been diverted and initiates the update to the first switch when the traffic is diverted.

### TECHNICAL BACKGROUND

Computing environments deploy a variety of physical computing elements to provide the desired operations for the tenant or tenants of the computing environment. These elements may include physical computing systems, such as desktop computers and servers, may comprise switches, routers, and other networking devices, or may comprise some other computing element. These computing elements may require updates that can provide additional features from the computing elements or can provide fixes to one or more issues with the software or firmware configurations of the corresponding computing element.

In some implementations, a switch in a computing environment may require an update that involves a stoppage or restart of the switch. The update may, in turn, cause downtime for the switch, which can cause dropped or missed packets from other connected computing elements, such as host computing systems, switches, or routers. These dropped packets may cause errors for the applications executing in the environment and may cause inefficiencies for the overall operations of the tenant or tenants.

### SUMMARY

The technology described herein manages the update process associated with switches in a computing environment. In one implementation, a control service identifies a request to update a first switch in a computing network and initiates an update to a network configuration for the first switch to divert network traffic from the first switch to a second switch in the computing network, wherein the second switch provides an alternate path to a path provided by the first switch. The control service further monitors the network traffic for the first switch to determine when the network traffic has been diverted the second switch and, in response to determining that the network traffic has been diverted, initiates an update to the first switch.

The control process may further identify a startup event for a first switch following the update and compare a first routing table on the first switch to a second routing table on the second switch to determine when the first routing table is updated. When the first routing table is updated, the control service may initiate a second update to the network configuration for the first switch to permit ingress data packets at the first switch.

### BRIEF DESCRIPTION OF THE DRAWINGS

FIG. 1 illustrates a computing environment to manage the restart of switches according to an implementation.

FIG. 2 illustrates an operation of a control service to trigger the update of a switch in a computing environment according to an implementation.

FIG. 3 illustrates an operation of a control service to permit ingress packets at the switch according to an implementation.

FIG. 4 illustrates a timing diagram of managing an update to a switch according to an implementation.

FIG. 5 illustrates a timing diagram to integrate a switch into a computing environment after startup according to an implementation

FIG. 6 illustrates a control service computing system to manage updates to switches in a computing environment according to an implementation.

### DETAILED DESCRIPTION

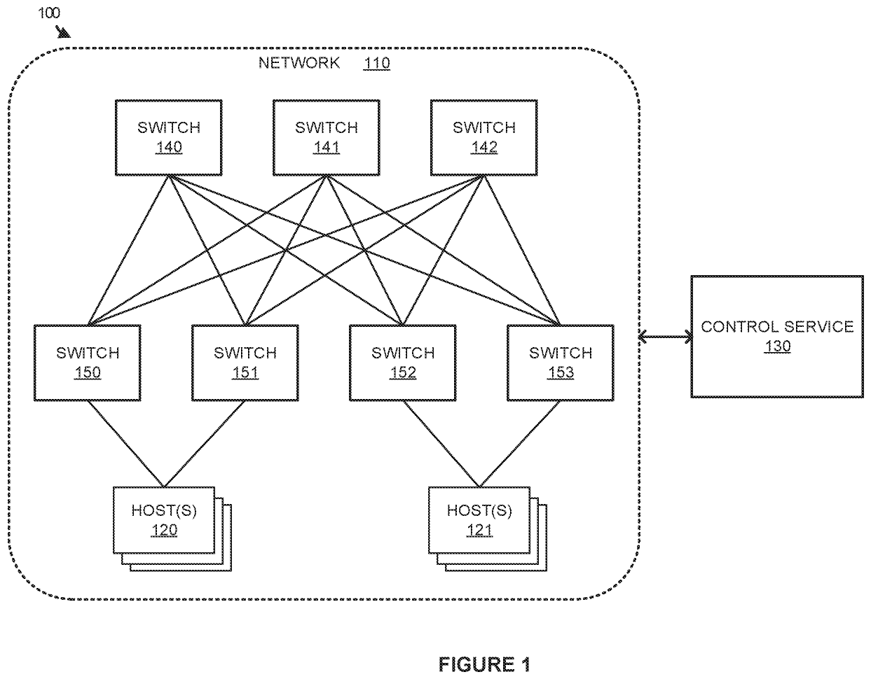

FIG. 1 illustrates a computing environment 100 to manage the restart of switches according to an implementation. Computing environment 100 includes network 110 with control service 130. Switches 140-142 are coupled to switches 150-153 and switches 150-153 are coupled to hosts 120-121. Although not depicted as directly connected to switches 140-142, switches 150-153, and hosts 120-121 in network 110, it should be understood that control service 130 may directly communicate with each of the elements to obtain telemetry information and communicate configuration changes to the network elements.

In operation, switches 140-142 and switches 150-153 are deployed in network 110 to provide connectivity for hosts 120-121, wherein hosts 120-121 represent computing systems each capable of hosting one or more virtual nodes. The virtual nodes may comprise full operating system virtual machines, containers, or some other containerized endpoint. Switches 140-142 and switches 150-153 may provide various functions, including connecting services between each of the hosts, connecting the hosts to routing elements to access external networks like the internet, provide quality of service management for data packets traversing the switch, implement firewalls, or provide some other operation with respect to the network traffic.

Here, switches 140-142 are representative of switches in a higher topology tier from switches 150-153, wherein switches 140-142 may be referred to as backbone switches, while switches 150-153 represent leaf switches. Although demonstrated in the example of FIG. 1 with three backbone switches, it should be understood that the backbone may use two, four, or any other number of backbone switches. A backbone switch may provide additional bandwidth in relation to switches 150-153, while switches 150-153 may be used to provide redundancy for hosts 120-121 to access switches 140-142 and any outside networks. For example, when switch 150 is unavailable in network 110, such as for an update to software or firmware associated with switch 150, switch 151 may be used to provide the connectivity for host(s) 120.

In some implementations, control service 130 may be used to control the operations and processes involved in updating a switch in network 110. Control service 130 may communicate with switches 140-142, switches 150-153, and hosts 120-121 using a control plane that is used to configure the network for forwarding data packets in the data plane (e.g., ingress and egress data packets for hosts 120-121). These configurations may be used to trigger updates, implement quality of service preferences, firewall preferences, or some other configuration of the network. To manage an update, control service 130 may identify a request to update a particular switch, such as switch 150, and initiate a network configuration modification to divert network traffic away from the affected switch. For example, in an update for switch 150, control service may configure switch 150 to advertise to its connected computing systems, switches 140-142 and host(s) 120, that an alternate path over switch 151 should be preferred to the path over switch 150. Once advertised, control service 130 may monitor the network traffic over switch 150 to determine when the network traffic has been diverted to switch 151 that provides the alternate path. Using the example of switch 150, when packets are no longer identified from switches 140-142 and host(s) 120, control service 130 may determine that the network traffic is diverted and initiate the update associated with switch 150.

When switch 150 restarts from the update and is identified by control service 130, control service 130 may monitor switch 150 to determine when a routing table on the switch is updated and initiate a second network configuration modification to permit switch 150 to receive data packets from switches 140-142 and host(s) 120. In some implementations, switch 150 may establish a connection with peers using a control protocol, such as Border Gateway Protocol (BGP), to exchange control packets that include path or route configuration information for populating the routing table on switch 150. This routing table is used to direct ingress and egress packets for hots(s) 120-121 over switches 140-142, wherein each entry in the routing table indicates where (i.e. what switch, host, etc.) a packet should be delivered based on a destination internet protocol (IP) address or IP subnet. Once a routing table is built from the peer connections on switch 150, switch 150 may advertise to switches 140-142 and host(s) 120 that it is available to communicate data packets in network 110.

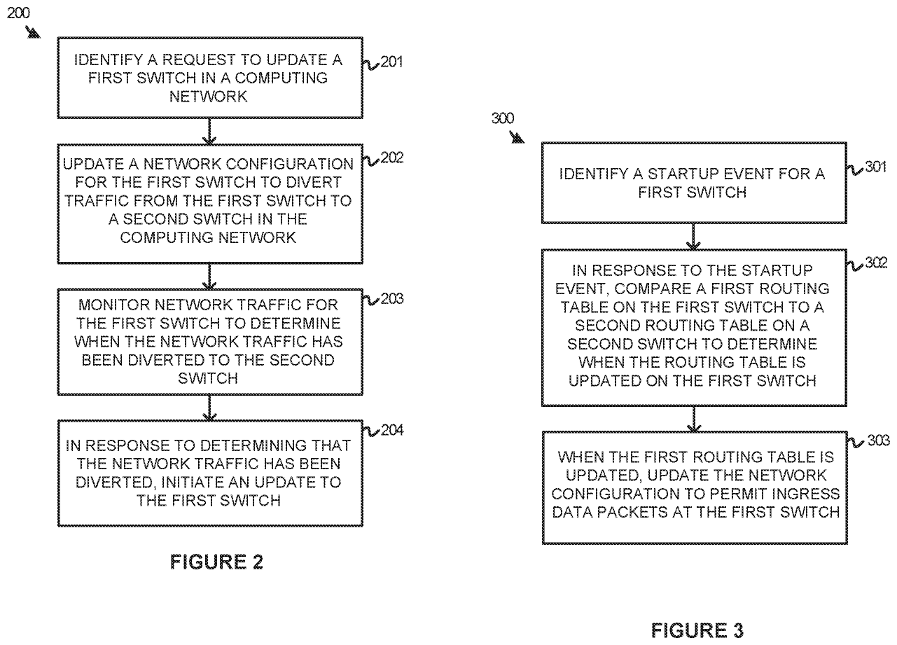

FIG. 2 illustrates an operation 200 of a control service to trigger the update of a switch in a computing environment according to an implementation. The steps of operation 200 are referenced parenthetically in the paragraphs that follow with reference to systems and elements of computing environment 100 of FIG. 1.

As depicted, operation 200 includes identifying (201) a request to update a first switch in a computing network. In response to the request, the control service initiates (202) an update to a network configuration for the first switch to divert network traffic from the first switch to a second switch in the computing network, wherein the second switch provides an alternate path for a path provided by the first switch. In some implementations, an administrator or an automated process may indicate a request to control service 130 to update firmware or software associated with a switch in switches 140-142 or switches 150-153. In response to the request, control service 130 may communicate a notification to the corresponding switch to divert the traffic to an alternative path over another switch. For example, for an update to switch 151, control service 130 may communicate a network configuration update to divert traffic to switch 150. In some implementations, the network configuration update may indicate to switch 151 to advertise a higher network cost associated with switch 151. This advertisement may comprise an AS-path notification to switches 140-142 using BGP, wherein the AS-path notification is used to indicate that switch 150 is preferred over switch 151. As a result, switches 140-142 will direct incoming packets through switch 150 and not use switch 151. The update to the network configuration may also update a Link Aggregation Control Protocol (LACP) configuration for host(s) 120 to communicate with switch 151, wherein LACP is used to manage link aggregation for data connections for host(s) 120. The update to the network configuration may be used to stop the use of switch 151 during the update and funnel the communications to another switch in network 100.

After initiating the update to the network configuration for switch 151, the control service further monitors (203) the network traffic for the first switch to determine when the network traffic has been diverted to the second switch. Once the traffic is diverted, the control service initiates (204) an update to the first switch. In some implementations, control service 130 may use the control plane to monitor bytes received, packets received, bandwidth used, and other networking statistics associated with the switch to be updated. For example, when the update is required for switch 151, control service 130 may monitor networking statistics associated with switch 151 to determine when the network traffic satisfies one or more criteria to trigger the update of the switch (e.g., a number of packets received by the switch falls below a threshold for a period of time). Once the one or more criteria are satisfied, control service 130 may initiate the update to switch 151, wherein the update may be used to fix one or more bugs issues with the switch, provide new features, or provide some other update in association with switch 151.

FIG. 3 illustrates an operation 300 of a control service to permit ingress packets at the switch according to an implementation. The steps of operation 300 are referenced parenthetically in the paragraphs that follow with reference to systems and elements of computing environment 100 FIG. 1.

As depicted, operation 300 includes identifying (301) a startup event for a first switch. The startup even may comprise completing an update for the switch or may comprise an initial startup of a new switch in the computing network. For example, when control service 130 initiates an update for switch 151, control service 130 may monitor for a notification from switch 151 indicating that the switch is available to rejoin network 110. Once the startup event is identified, the control service further compares (302) a first routing table on the first switch to a routing table on the second switch to determine when the first routing table is updated for the first switch. In some implementations, when a restart occurs for a switch, such as switch 151, the switch may establish BGP sessions with peers, including switches 140-142, wherein BGP may be used to exchange path or route information to populate a routing table for switch 151. As the table is populated by exchanging information from the peer switches, control service 130 may compare the routing table from the first switch with a routing table of the second switch that provides an alternative route for the first switch to determine when the routes match and the first routing table is updated.

Once updated, operation 300 will initiate (303) an update to the network configuration for the first switch to permit ingress data packets at the first switch. In some implementations, the second update may be used to trigger AS-path path notification to other switches coupled to the restarted switch. For switch 151, this may include communicating an AS-path cost update to switches 140-142 to indicate the availability of switch 151 to communicate packets. Additionally, switch 151 may update a LACP configuration associated with host(s) 120 to permit packets to be received from host(s) 120. Each of these updates may be used to reflect the availability of switch 151 to be used in conjunction with switch 150.

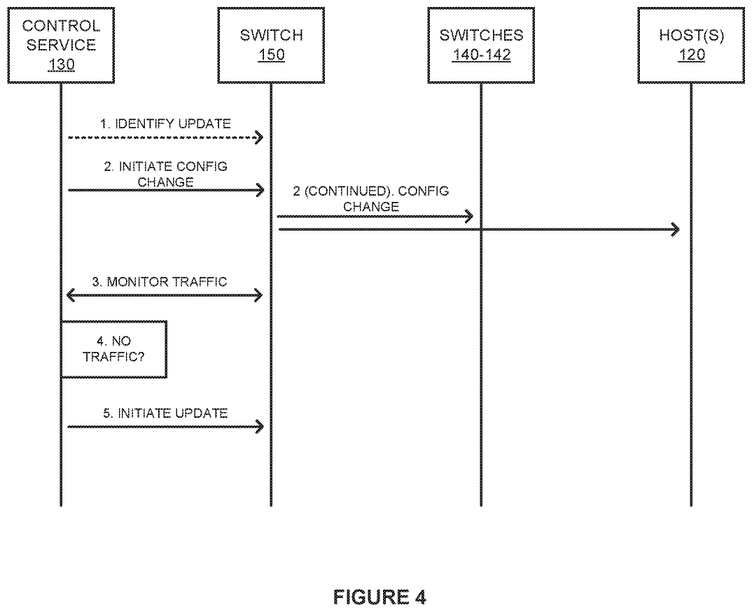

FIG. 4 illustrates a timing diagram 400 of managing an update to a switch according to an implementation. Timing diagram 400 includes control service 130, switch 150, switches 140-142 and host(s) 120 from computing environment 100 of FIG. 1.

In operation, control service 130 identifies, at step 1, an update to switch 150, wherein the switch may be triggered by an automated process or an administrator associated with switch 150. In response to the update request, control service 130 initiates, at step 2, a networking configuration change for switch 150 that is used to direct future connections to another switch that provides an alternate route. In particular, because switch 151 provides an alternate route between server(s) 120 and switches 140-142, the networking configuration update may be used to direct the communications over switch 151 instead of using switch 150. In some implementations, in response to control service 130 initiating the configuration change, switch 150 may update, using BGP, a path cost associated with switches 140-142 communicating with switch 150, such that switches 140-142 will prefer switch 151 over switch 150. Additionally, switch 150 may update a LACP configuration for host(s) 120, such that host(s) 120 will prefer switch 151 over switch 150.

Once a configuration change is initiated by control service 130, control service 130 may obtain or monitor, at step 3, telemetry information from switch 150 indicative of networking traffic statistics over switch 150. The statistics may include the quantity of packets received by switch 150, the bytes of data traversing switch 150, or some other information associated with the networking traffic. From the networking traffic, control service 130 determines when the traffic satisfies one or more criteria, at step 4. In some implementations, control service 130 may determine when one or more networking statistics fall below threshold values for a period of time. For example, control service 130 may determine when the number of packets received by switch 150 falls below a threshold. Once it is determined that the traffic has been diverted to switch 151, control service 130 may initiate the update to switch 150, at step 5.

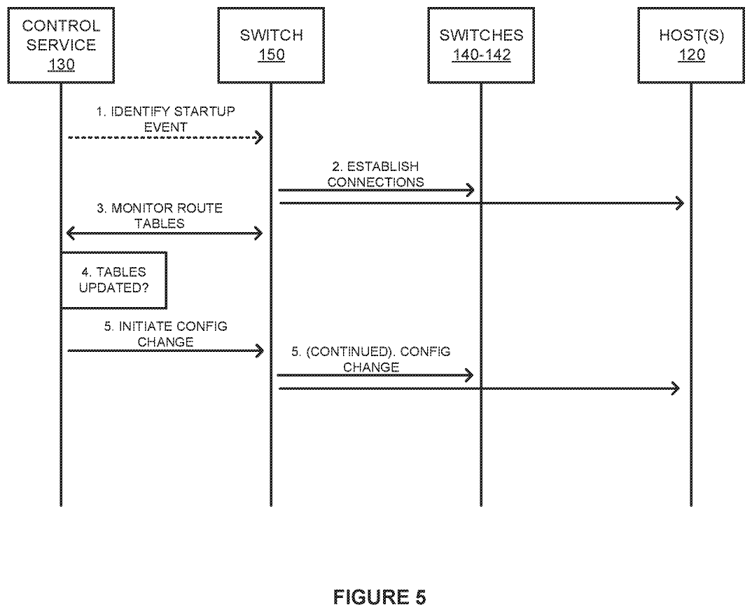

FIG. 5 illustrates a timing diagram 500 to integrate a switch into a computing environment after startup according to an implementation. Timing diagram 500 includes control service 130, switch 150, switches 140-142 and host(s) 120 from computing environment 100 of FIG. 1. Timing diagram 500 may be a continuation of timing diagram 400 of FIG. 4, demonstrating the restart of a switch following the update to the switch. However, timing diagram may also represent any start or restart of a switch in a computing network to provide switching functionality in a computing network.

As depicted, control service 130 identifies, at step 1, a startup event for switch 150, wherein the startup event may comprise a notification from switch 150 indicating it is ready to join the network. Once the startup event is identified, switch 150 may establish connections with its peer switches and, in some examples, coupled host(s) 120. The reestablished connections may include BGP sessions that can be used to configure switch 150 in rejoining the computing network. In particular, the BGP sessions may be used to obtain entries for a routing table maintained by switch 150, wherein the routing table is a database that keeps track of paths for different addresses and uses the paths to determine which way to forward traffic, such as to a next hop router, a host, or some other destination.

As the switch 150 updates a local routing table based on information from switches 140-142, control service 130 monitors, at step 3, the routing table of switch 150. While monitoring the routing table for switch 150, control service 130 compares, at step 4, the entries in the routing table of switch 150 to entries in a routing table for switch 151 to determine when the table for switch 150 is updated. In comparing the routing tables, control service 130 may determine when the entries in the routing table for switch 150 are updated based on if the entries match or include path addressing entries for the routing table of switch 151. In response to determining that the routing table for switch 150 is updated, control service 130 may initiate a configuration change, at step 5, that permits ingress packets from switches 140-142 and host(s) 120 to be communicated to switch 150.

In some implementations, to initiate the configuration change, control service 130 may instruct switch 150 to indicate to switches 140-142 a new path cost associated with switch 150. In particular, using BGP, switch 150 may change the path cost associated with the connection from switches 140-142 from a first value to a second value, wherein the second value may increase traffic to switch 150. In particular, the path cost or AS-path notification may be used by switches 140-142 to select a switch from switches 150-151 for a communication. Based on the change in the path cost, switches 140-142 may select additional packets to be communicated over switch 150 rather than exclusively using switch 151. Additionally, switch 150 may modify a LACP configuration associated with host(s) 120 to permit packets to be communicated over switch 150. As a result, host(s) 120 may communicate at least a portion of their packets over switch 150 opposed to switch 151.

In some implementations, once an update is performed on switch 150, similar operations may be performed to update the second switch in the pair. In particular, because switch 151 could provide failover protection for switch 150 during the first update, a second update may be triggered that temporarily moves traffic to communicating exclusively over switch 150 while switch 151 is updated. Advantageously, each of the switches may be updated separately, while maintaining connections for the connected hosts.

Although demonstrated in the examples above as updating a leaf switch in a computing network, it should be understood that similar operations may be performed for any switch in a computing network that has an alternate path (switch) for packets. For example, if switches 140-142 were coupled to a router, a switch in switches 140-142 may be updated in a similar manner by diverting traffic to one or more other switches that provide alternate routes to the switch being updated. Once the traffic is diverted using BGP to advertise a higher cost path to the updating switch, control service 130 may initiate an update to the switch. Once updated, control service 130 may monitor for when the switch includes an updated routing table by comparing the routing table to the one or more other switches that provide the alternate route. When updated, may initiate a networking configuration update for the switch, permitting the switch to receive data packets from switches 150-153 and the router coupled to the updated switch.

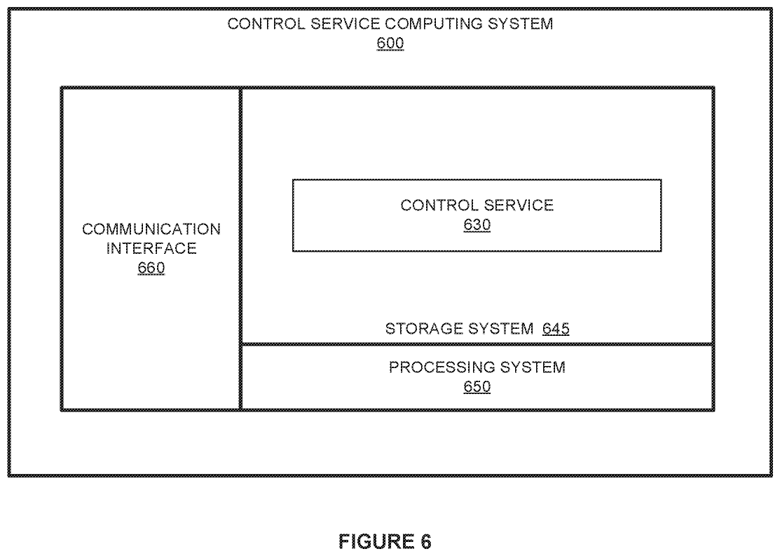

FIG. 6 illustrates a control service computing system 600 to manage updates to switches in a computing environment according to an implementation. Computing system 600 is representative of any computing system or systems with which the various operational architectures, processes, scenarios, and sequences disclosed herein for a control service can be implemented. Computing system 600 is an example of control service 130 of FIG. 1, although other examples may exist. Computing system 600 includes storage system 645, processing system 650, and communication interface 660. Processing system 650 is operatively linked to communication interface 660 and storage system 645. Communication interface 660 may be communicatively linked to storage system 645 in some implementations. Computing system 600 may further include other components such as a battery and enclosure that are not shown for clarity.

Communication interface 660 comprises components that communicate over communication links, such as network cards, ports, radio frequency (RF), processing circuitry and software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format—including combinations thereof. Communication interface 660 is configured to communicate with switches in a computing environment to obtain telemetry information associated with the switches and to provide control information to update communication configurations to the switches. Communication interface 660 may further communicate with routers, host computing systems, or other computing elements to manage the network configurations for the computing elements, including firewalls, quality of service, or some other configuration associated with the network.

Processing system 650 comprises microprocessor and other circuitry that retrieves and executes operating software from storage system 645. Storage system 645 may include volatile and nonvolatile, removable and non-removable media implemented in any method or technology for storage of information, such as computer readable instructions, data structures, program modules, or other data. Storage system 645 may be implemented as a single storage device, but may also be implemented across multiple storage devices or sub-systems. Storage system 645 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing system 650 is typically mounted on a circuit board that may also hold the storage system. The operating software of storage system 645 comprises computer programs, firmware, or some other form of machine-readable program instructions. The operating software of storage system 645 comprises control service 630 capable of providing at least operation 200 of FIG. 2 and operation 300 of FIG. 3. The operating software on storage system 645 may further include an operating system, utilities, drivers, network interfaces, applications, or some other type of software. When read and executed by processing system 650 the operating software on storage system 645 directs computing system 600 to operate as described herein.

In at least one implementation, control service 630 directs processing system 650 to identify a request to update a first switch in a computing network. In response to the request, control service 630 initiates an update to a network configuration for the first switch to divert traffic from the first switch to at least one second switch, wherein the second switch provides an alternate path or failover for the updating first switch. In some implementations, the update to the network configuration may include triggering the first switch to provide a BGP notification to one or more other, higher tier switches, indicating a higher cost of communicating with the first switch over the at least one second switch. In turn, this would trigger the one or more other switches to direct communications to the second switch. Additionally, if the first switch is coupled to one or more hosts, the first switch may update a LACP configuration for the one or more hosts, such that future data packets are directed at the second switch over the first switch.

Once the networking configuration is update is initiated for the first switch, control service 630 directs processing system 660 to monitor the network traffic for the first switch to determine when the network traffic has been diverted to the at least one second switch. In some implementations, control service 630 may monitor the number of data packets received by the first switch, the number of bytes received by the first switch, or some other telemetry statistic associated with the first switch. Once the statistics satisfy one or more criteria, control service 630 may determine that the traffic has been diverted to the at least one second switch. For example, when the number of packets received by the first switch falls below a threshold amount for a period of time, control service 630 may determine that the traffic has been diverted to the at least one second switch. In response to determining that the network traffic has been diverted, control service 630 will direct processing system 660 to initiate an update to the first switch, wherein the update may be used to add features to the switch or may be used to fix one or more bugs associated with the firmware or software for the switch.

In addition to initiating an update to a switch, control service 630 may further be used during the restart or startup of a switch in the computing network. In one implementation, control service 630 may direct processing system 660 to identify a startup event for the first switch following the update. The startup event may include receiving a notification from the switch using the control plane indicating the availability of the switch. In response to the startup event, control service 630 directs processing system 660 to compare a first routing table on the first switch to a second routing table on the at least one second switch to determine when the first routing table is updated. In some examples, as the at least one second switch provides an alternate or failover path for packets traversing the first switch, entries in the routing table for the at least one second switch should match those of the first switch. To update the routing table, the first switch may establish BGP sessions with peer switches to update the routing table. As the routing table is being updated, control service 630 may compare the entries in the routing table of the first switch to determine when the entries match the entries for the at least one second switch. Once the entries match and the routing table for the first switch is updated, control service 630 directs processing system 660 to initiate a second update to the network configuration for the first switch to permit ingress data packets at the first switch.

In some implementations, the update to the networking configuration may include modifying the path cost associated with the first switch. In particular, using BGP, the first switch may indicate a lower path cost associated with communicating with the first switch, wherein the lower path cost may permit the first switch to receive data packets from the BGP peers alongside the at least one second switch. Further, in some implementations, when the first switch is coupled to one or more hosts, the first switch may update a LACP configuration associated with the first switch, such that the first switch may receive data packets from the one or more hosts alongside the at least one second switch.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method comprising:
identifying a request to update a first switch in a computing network;
initiating an update to a network configuration for the first switch to divert network traffic from the first switch to a second switch in the computing network, wherein the second switch provides an alternate path for a path provided by the first switch;
monitoring the network traffic for the first switch to determine when the network traffic has been diverted to the second switch;
in response to determining that the network traffic has been diverted, initiating an update to the first switch;
identifying a startup event for the first switch following the update;
in response to the startup event, comparing a first routing table on the first switch to a second routing table on the second switch to determine when the first routing table is updated; and
when the first routing table is updated, initiating a second update to the network configuration for the first switch to permit ingress data packets at the first switch.

2. (canceled)

3. The method of claim 1, wherein identifying the startup event for the first switch comprises receiving a notification from the first switch indicating a completion of the update.

4. The method of claim 1, wherein initiating the update to the network configuration for the first switch comprises notifying the first switch to communicate a higher path cost associated with the first switch to one or more switches coupled to the first switch.

5. The method of claim 1, wherein initiating the update to the network configuration for the first switch comprises updating a Link Aggregation Control Protocol (LACP) configuration for one or more computing systems to communicate using the second switch over the first switch.

6. The method of claim 5, wherein the one or more computing systems each host one or more virtual nodes.

7. The method of claim 1, wherein monitoring the network traffic for the first switch to determine when the network traffic has been diverted to the second switch comprises determining when the network traffic from one or more hosts to the first switch meets one or more criteria.

8. The method of claim 1, wherein monitoring the network traffic for the first switch to determine when the network traffic has been diverted to the second switch comprises determining when the network traffic from one or more other switches to the first switch meets one or more criteria.

9. A computing apparatus comprising
a storage system;
a processing system operatively coupled to the storage system;
program instructions stored on the storage system that, when executed by the processing system, direct the computing apparatus to:
identify a request to update a first switch in a computing network;
initiate an update to a network configuration for the first switch to divert network traffic from the first switch to a second switch in the computing network, wherein the second switch provides an alternate path for a path provided by the first switch;
monitor the network traffic for the first switch to determine when the network traffic has been diverted to the second switch;
in response to determining that the network traffic has been diverted, initiate an update to the first switch;
identify a startup event for the first switch following the update;
in response to the startup event, compare a first routing table on the first switch to a second routing table on the second switch to determine when the first routing table is updated; and
when the first routing table is updated, initiate a second update to the network configuration for the first switch to permit ingress data packets at the first switch.

10. (canceled)

11. The computing apparatus of claim 9, wherein identifying the startup event for the first switch comprises receiving a notification from the first switch indicating a completion of the update.

12. The computing apparatus of claim 9, wherein initiating the update to the network configuration for the first switch comprises notifying the first switch to communicate a higher path cost associated with the first switch to one or more switches coupled to the first switch.

13. The computing apparatus of claim 9, wherein initiating the update to the network configuration for the first switch comprises updating a Link Aggregation Control Protocol (LACP) configuration for one or more computing systems to communicate using the second switch over the first switch.

14. The computing apparatus of claim 13, wherein the one or more computing systems each host one or more virtual nodes.

15. The computing apparatus of claim 9, wherein monitoring the network traffic for the first switch to determine when the network traffic has been diverted to the second switch comprises determining when the network traffic from one or more hosts to the first switch meets one or more criteria.

16. The computing apparatus of claim 9, wherein monitoring the network traffic for the first switch to determine when the network traffic has been diverted to the second switch comprises determining when the network traffic from one or more other switches to the first switch meets one or more criteria.

17. A system comprising:
a plurality of switches; and
a control computing system communicatively coupled to the plurality of switches and configured to:
identify a startup event for a first switch of the plurality of switches;
in response to the startup event, compare a first routing on the first switch to a second routing table of a second switch of the plurality of switches to determine when the first routing table is updated, wherein the second switch provides an alternate path for a path provided by the first switch; and
when the first routing table is updated, initiate an update to a network configuration for the first switch to permit ingress data packets at the first switch.

18. The system of claim 17, wherein the startup event occurs in response to completing an update to the first switch, and wherein the control computing system is further configured to:
identify a request to update the first switch;
initiate a second update to the network configuration for the first switch to divert network traffic from the first switch to the second switch;
monitor the network traffic for the first switch to determine when the network traffic has been diverted to the second switch; and
in response to determining that the network traffic has been diverted, initiate the update to the first switch.

19. The system of claim 18, wherein initiating the second update to the network configuration for the first switch comprises notifying the first switch to communicate a higher path cost associated with the first switch to one or more switches coupled to the first switch.

20. The system of claim 18, wherein initiating the second update to the network configuration for the first switch comprises updating a Link Aggregation Control Protocol (LACP) configuration for one or more computing systems to communicate using the second switch over the first switch.
